(19) United States
(12) Patent Application Publication
(10) Pub. No.: US 2012/0273475 A1
(43) Pub. Date: Nov. 1, 2012

(54) AUTOMATIC MATTRESS HEATING APPARATUS

(76) Inventor: Jung Ho An, Icheon-si (KR)

(21) Appl. No.: 13/391,925

(22) PCT Filed: Sep. 21, 2011
(86) PCT No.: PCT/KR2011/006974

§ 371 Date: Feb. 23, 2012

(30) Foreign Application Priority Data
Sep. 7, 2010 (KR) 10-2010-0095845

(51) Int. Cl. A47C 21/04; H05B 3/34; H05B 1/02

(52) U.S. Cl. 219/217; 219/509; 219/518; 219/508; 219/481; 219/510

(57) ABSTRACT

Disclosed is an automatic mattress heating apparatus which automatically heats a mattress selectively or completely. An automatic mattress heating apparatus which automatically heats a part or the entirety of a heated area of a mattress according to the number of sleeping persons or the positions of the sleeping persons. The automatic mattress heating apparatus is safely and conveniently used while properly providing heat according to the number of sleeping persons or the positions of the sleeping persons without waste of energy.

### CROSS REFERENCE TO RELATED APPLICATIONS

This application is a National Stage of International Application No. PCT/KR2011/006974, filed on Sep. 21, 2011, which claims the priority of Korean Application No. 10-2010-0095845 filed Sep. 27, 2010. The contents of the prior applications mentioned above are incorporated herein by reference in its entirety.

### TECHNICAL FIELD

The present invention relates to an automatic mattress heating apparatus which automatically heats a mattress for beds selectively or completely, and more particularly, to an automatic mattress heating apparatus which automatically heats a part or the entirety of a heated area of a mattress according to the number of sleeping persons or the positions of the sleeping persons.

### BACKGROUND ART

Beds have been used in most homes, as the number of persons using beds gradually increases due to modernization of living and change of residential culture toward apartment houses. A bed includes a bed frame and a mattress installed on the bed frame, and mattresses are variously divided into a spring mattress, a latex mattress, a stone mattress, a loess mattress, etc. according to employed materials or cushion types.

A bed employing the spring mattress or the latex mattress has a cushioning function and has advantages, such as comfortableness and ease during sleeping. However, the bed employing the spring mattress or the latex mattress is not provided with a separate heating unit and thus has a disadvantage, such as being cold during the winter.

Due to the above disadvantage, most mattress users additionally use an electric heater executing a heating function, such as an electric pad, on the upper surfaces of mattresses. Therefore, in order to solve the above disadvantage, a heating bed provided with a heating element providing a heating function to a mattress has been developed now.

However, since the heating bed uniformly heats the entirety of the mattress using the heating element provided on the upper surface of the mattress or embedded in the mattress, if a user preferring a high-temperature sleeping condition of a large-size bed which two or more persons use and a user disliking such a sleeping condition together use the heating bed, it is impossible to respectively adjust temperatures desired by all users. Therefore, it is very inconvenient for users preferring different sleeping conditions to use such a heating bed.

Accordingly, Korean Utility Model Registration Application No. 20-1998-0010429 discloses “temperature adjusting apparatus of heating bedding for 2 users” which executes a heating function only at a portion where heating is desired in a bed for 2 users.

However, in such a temperature adjusting apparatus of the heating bedding for 2 users, as shown in FIG. 1, heating lines A and B separated from each other are respectively embedded in a bed, positive terminals of the heating lines A and B are connected in common to a positive terminal of a temperature controller 2 via respective switches, and negative terminals of the heating lines A and B are connected in common to a negative terminal of the temperature controller 2.

In the temperature adjusting apparatus of the heating bedding for 2 users, since the heating lines A and B are arranged at two halves divided from each other based on the central line of the bed, if one user sleeps on the bed, the user lies at the central portion of the bed but no heating line is disposed at the central portion and thus no heating function is provided to the central portion. Further, even if one user sleeps on the bed, power is supplied to both heating lines A and B, thus causing severe waste of energy.

In order to prevent such waste of energy, if power is supplied only to the heating line A or the heating line B, a sleeping person lies at the edge of the bed and thus may fall or drop down to the floor during sleeping, thereby increasing danger of accidents.

### DISCLOSURE

### Technical Problem

An object of the present invention devised to solve the problem lies on an automatic mattress heating apparatus which is safely and conveniently used while properly providing heat according to the number of sleeping persons or the positions of the sleeping persons without waste of energy.

Another object of the present invention devised to solve the problem lies on an automatic mattress heating apparatus which executes a heating function only at a position where a sleeping person is located to prevent waste of energy while providing the optimal sleeping conditions.

### Technical Solution

The object of the present invention can be achieved by providing an automatic mattress heating apparatus including a power supply unit, a heating element for beds including a central heating part and peripheral heating parts heated by power supplied from the power supply unit and executing a heating action, a switching unit executing switching of the power supplied from the power supply unit to supply the power to at least one of the central heating part and the peripheral heating parts of the heating element for beds, and a control unit to control switching of the power by the switching unit, wherein the central heating part is disposed to heat a central portion of a heated area of a mattress, and the peripheral heating parts are disposed to heat remaining peripheral portions of the heated area of the mattress except for the central portion.

The central heating part may be disposed in the lengthwise direction from the central portion of the upper region of the mattress to the central portion of the lower region of the mattress, and the peripheral heating parts may be disposed adjacent to both sides of the central heating part.

The automatic mattress heating apparatus may further include a sleeping person sensing unit provided at at least one of a position where the central heating part is disposed and positions where the peripheral heating parts are disposed so as to sense the sleeping position of a sleeping person. The sleeping person sensing unit may include load sensors to respectively sense load applied to the central portion at which the central heating part is disposed and loads applied to the peripheral portions at which the peripheral heating parts are disposed. Thereby, the control unit may receive a sensing signal corresponding to a sensing result of the sleeping person sensing unit from the sleeping person sensing unit, and control the switching unit to supply the power to at least one of the central heating part and the peripheral heating parts at which the sleeping person is located according to the received sensing signal.

The central heating part may include a plurality of small heating circuits including heating lines disposed to receive power from the power supply unit, independently of the peripheral heating parts, the peripheral heating units may include a plurality of other small heating circuits including heating lines disposed to receive power from the power supply unit, independently of the central heating part, and the sleeping person sensing unit may be provided adjacent to the small heating circuits of the central heating part and the small heating circuits of the peripheral heating parts.

The central heating part and the peripheral heating parts of the heating element for beds may respectively include one of a planar-type heating element, a mesh-type heating element and a strip-type heating element, the planar-type heating element may be formed in one of a first shape woven by disposing heating lines in a wave form to supply power to the central heating part and the peripheral heating parts on a planar fabric element knitted of fiber yarns supplied as wefts and warps, a second shape obtained by fixing heating lines supplied as embroidery yarns to a planar element formed of a material selected from among fabric, leather, non-woven fabric and foam, using an under thread through embroidery, a third shape obtained by disposing heating lines within a planar element formed of a material selected from among fabric, leather, non-woven fabric and foam, and a fourth shape obtained by disposing heating lines on the surface of a planar element using a conductive polymer, the mesh-type heating element may be formed in a fifth shape woven by disposing heating lines in a wave form to supply power to the central heating part and the peripheral heating parts on a mesh-type planar element having a mesh net structure knitted of fiber yarns supplied as wefts and warps, and the strip-type heating element may be formed in a sixth shape woven by disposing heating lines in a wave form to supply power to the central heating part and the peripheral heating parts on a strip-type planar element knitted of fiber yarns supplied as wefts and warps. Each of the heating lines may include a central yarn disposed at the central area, a plurality of conductive yarns coated with an insulating material and wound on the central yarn, and a plurality of outer fiber yarns wound on the outer surfaces of the plurality of conductive yarns, the central yarn, the plurality of conductive yarns and the plurality of outer fiber yarns being formed in one bundle.

The automatic mattress heating apparatus may further include protective yarns having a greater diameter than the diameter of the heating lines and disposed adjacent to the heating lines along the disposition path of the heating lines to protect the heating lines from friction, and temperature control lines having resistance characteristics differing from the heating lines and disposed together with the heating lines along the disposition path of the heating lines to apply a resistance value changed, when the heating lines are heated above a predetermined temperature, to the control unit. Particularly, the control unit may control power applied to the heating lines according to the resistance value applied through the temperature control line to prevent the heating lines from being overheated.

The automatic mattress heating apparatus may further include heat transfer yarns having excellent heat transfer characteristics to uniformly and rapidly transfer heat when the central heating part and the peripheral heating parts are heated.

The heating element formed in each shape at the central heating part and the peripheral heating parts may be divided into heating line weaving sections in which the heating lines are woven integrally with the planar element, and heating line exposing sections in which the heating lines are not woven with the planar element and are exposed to the outside.

The central heating part and the peripheral heating parts may be integrated into one unit, or the central heating part and the peripheral heating parts may be separately provided.

The automatic mattress heating apparatus may further include sensor units disposed adjacent to the central heating unit and the peripheral heating units, each of the sensor units may include at least one first sensor line formed of a conductive linear member and provided with a connection terminal formed at one end thereof and at least one connection terminal formed at the other end thereof, a second sensor line formed of another conductive linear member and provided with a connection terminal formed at one end thereof and at least one connection terminal formed at the other end thereof, and a detection element connected to the electrode terminals of the first and second sensor lines, and the first sensor line may be formed by twisting the conductive linear member and the second sensor line may be twisted with the first sensor line. Particularly, the detection element may include at least one of a temperature detection element and a moisture detection element.

The automatic mattress heating apparatus may further include a moisture sensor at at least one of the position of the central heating part and the positions of the peripheral heating parts. Thereby, the control unit may receive a sensing signal corresponding to a sensing result of the moisture sensor from the moisture sensor and output a warning or control the switching unit to supply power to at least one of the central heating part and the peripheral heating parts for a designated time according to the received sensing signal.

The power supply unit may include a central heating part power supply unit to supply first power corresponding to a power consumption rate of the central heating part and a peripheral heating part power supply unit to supply second power corresponding to power consumption rates of the peripheral heating parts, and a supply capacity of the first power supplied to the central heating part and a supply capacity of the second power supplied to the peripheral heating parts may be different.

In another aspect of the present invention, provided herein is an automatic mattress heating apparatus including a power supply unit, a heating element for beds including a first heating part and a second heating part heated by power supplied from the power supply unit and executing a heating action, a switching unit executing switching of the power supplied from the power supply unit to supply the power to one of the first heating part and the second heating part of the heating element for beds, and a control unit to control switching of the power by the switching unit, wherein the first heating part is disposed on the entire surface of a mattress to heat the entirety of a heated area of a mattress, and the second heating part overlaps the upper surface of the first heating part at the central portion of the mattress to heat the central portion of the heated area of the mattress.

### Advantageous Effects

An automatic mattress heating apparatus in accordance with the present invention executes a heating action only at a central portion of a bed for 2 persons when only one person sleeps on the bed, thus preventing waste of energy. Further, the automatic mattress heating apparatus prevents accidents, such as falling of a sleeping person generated using the conventional heating element in which heating portions are disposed at both sides, thus being safely and conveniently used.

Moreover, the automatic mattress heating apparatus controls a heated portion according to the position of a sleeping person sensed by a sleeping person sensing unit and thus provides proper heating according to movement of the sleeping person, thereby providing the optimal sleeping conditions.

### DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a view illustrating a conventional heating element for beds;

FIG. 2 is s view illustrating the technical spirit of an automatic mattress heating apparatus in accordance with the present invention;

FIG. 3 is a view illustrating an automatic mattress heating apparatus in accordance with a first embodiment of the present invention;

FIG. 4 is a view illustrating an automatic mattress heating apparatus in accordance with a first modification of the first embodiment of the present invention;

FIG. 5 is a view illustrating an automatic mattress heating apparatus in accordance with a second modification of the first embodiment of the present invention;

FIG. 6 is a view illustrating an automatic mattress heating apparatus in accordance with a third modification of the first embodiment of the present invention;

FIG. 7 is a view illustrating an automatic mattress heating apparatus in accordance with a fourth modification of the first embodiment of the present invention;

FIG. 8 is a view illustrating an automatic mattress heating apparatus in accordance with a fifth modification of the first embodiment of the present invention;

FIG. 9 is a view illustrating an automatic mattress heating apparatus in accordance with a second embodiment of the present invention;

FIGS. 10 and 11 are views illustrating an automatic mattress heating apparatus in accordance with a third embodiment of the present invention;

FIG. 12 is a view illustrating an automatic mattress heating apparatus in accordance with a fourth embodiment of the present invention;

FIG. 13 is a view illustrating an automatic mattress heating apparatus in accordance with a fifth embodiment of the present invention; and

FIG. 14 is a view illustrating an automatic mattress heating apparatus in accordance with a sixth embodiment of the present invention.

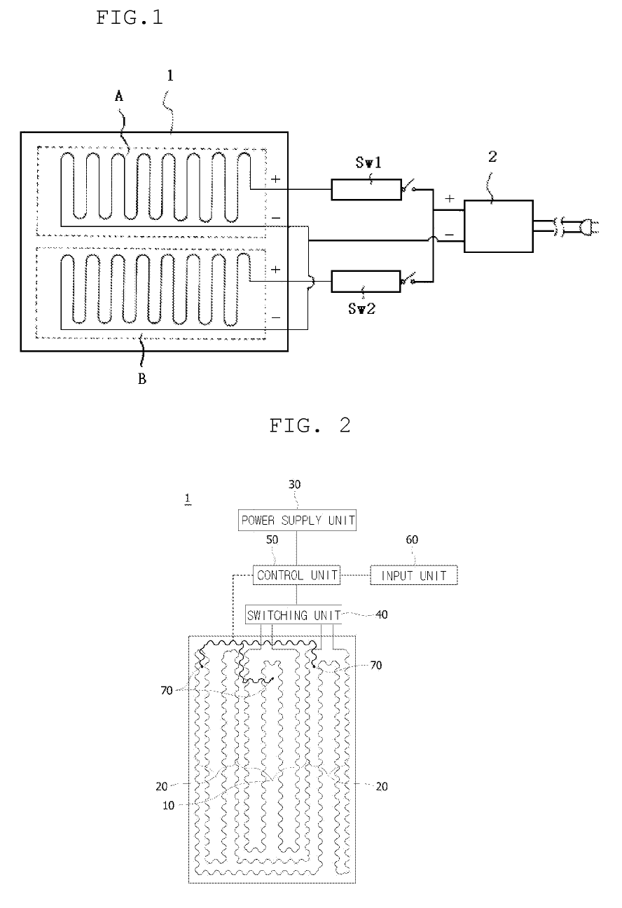

### BEST MODE

Reference will now be made in detail to the preferred embodiments of the present invention, examples of which are illustrated in the accompanying drawings, i.e., FIGS. 2 to 14. Wherever possible, the same reference numbers will be used throughout the drawings to refer to the same or like parts. In the following description of the present invention, a detailed description of known functions known to those skilled in the art and configurations incorporated herein will be omitted when it may make the subject matter of the present invention rather unclear.

FIG. 2 is s view illustrating the technical spirit of an automatic mattress heating apparatus in accordance with the present invention.

As shown in FIG. 2, an automatic mattress heating apparatus 1 in accordance with the present invention includes a heating element for beds including a central heating part 10 and peripheral heating parts 20, a power supply unit 30, and a switching unit 40. The automatic mattress heating apparatus 1 is characterized in that it is installed at the inside of a mattress 2 of a bed or is installed on the surface of the mattress 2 to execute a heating action while selectively or automatically heating the entirety or a specific portion of the mattress 2. In the present invention, the heating element for beds includes the central heating part 10 and the peripheral heating parts 20, and is heated by power supplied from the power supply unit 30 to provide the heating action.

Further, although the automatic mattress heating apparatus 1 in accordance with the present invention may be applied to various beds, such as a spring bed, a latex bed, a stone bed and a clay bed, hereinafter, the automatic mattress heating apparatus 1 applied to a spring bed or a latex bed which is widely used will be exemplarily described.

The power supply unit 30 means a power supply device which receives external commercial power, converts the external commercial power to power having proper output voltage and current amount corresponding to a power consumption rate of the heating element for beds, and supplies the converted power, and may employ one of an AC power supply method and a DC power supply method. The power supply unit 30 in accordance with the present invention employs the DC power supply method which can reduce generation of electromagnetic waves.

If the power supply unit 30 is formed as a single unit, the power supply unit 30 may be configured to have a power supply capacity to supply power corresponding to the total power consumption rate of the central heating part 10 and the peripheral heating parts 20 and to respectively supply corresponding power supply capacities to the central heating part 10 and the peripheral heating parts 20. For example, the power supply unit 30 includes a central heating part power supply unit to supply first power corresponding to a power consumption rate of the central heating part 10 to the central heating part 10, and a peripheral heating part power supply unit to supply second power corresponding to power consumption rates of the peripheral heating parts 20 to the peripheral heating parts 20. Preferably, a supply capacity of the first power supplied to the central heating part 10 and a supply capacity of the second power supplied to the peripheral heating parts 20 are differently set.

The central heating part 10 is disposed to heat a central portion of a heated area of the mattress 2, and the peripheral heating parts 20 are disposed to heat remaining peripheral portions of the heated area of the mattress 2 except for the central portion. In more detail, the central heating part 10 is disposed in the lengthwise direction from the central portion of the upper region of the mattress 2 to the central portion of the lower region of the mattress 2, and the peripheral heating parts 20 are disposed adjacent to both sides of the central heating part 10. Detailed configurations of the central heating part 10 and the peripheral heating parts 20 will be described in detail later.

The switching unit 40 serves to supply power supplied from the power supply unit 30 simultaneously to the central heating part 10 and the peripheral heating parts 20 or selectively to one of the central heating part 10 and the peripheral heating parts 20, and is operated by an input signal set by an operator under the control of a control unit 50.

Further, the automatic mattress heating apparatus 1 in accordance with the present invention may include an input unit 60 in a button type or a dial type to set a temperature, an operation time, an operation mode, etc., a temperature sensor (not shown) to sense a temperature, a reception unit (not shown) to receive a signal from a remote controller, and a display unit (not shown) to display the temperature or the operation time.

The automatic mattress heating apparatus 1 in accordance with the present invention further includes a sleeping person sensing unit 70 provided at at least one of a position where the central heating part 10 is disposed and positions where the peripheral heating parts 20 are disposed so as to sense the sleeping position of a sleeping person. A plurality of sleeping person sensing units 70 may be provided at the positions where the central heating part 10 and the peripheral heating parts 20 are disposed.

The sleeping person sensing unit 70 senses the position of a sleeping person and applies the sensed position to the control unit 50 so as to operate the switching unit 40 according to the position of the sleeping person, thereby allowing the central heating part 10 and the peripheral heating parts 20 to be selectively operated.

Although the sleeping person sensing unit 70 may employ various sensors to detect the position of a sleeping person, such as an optical sensor, the sleeping person sensing unit 70 in accordance with the present invention employs a load sensor to sense a load of a sleeping person. That is, the sleeping person sensing unit 70 includes load sensors which respectively sense load applied to the central portion of the mattress 2 where the central heating part 10 is disposed and loads applied to the peripheral portions of the mattress 2 where the peripheral heating parts 20 are disposed

The control unit 50 receives a sensing signal corresponding to a sensing result of the sleeping person sensing unit 70 from the sleeping person sensing unit 70, recognizes that a sleeping person is located at at least one of the central heating part 10 and the peripheral heating parts 20, and controls the switching unit 40 to supply power to at least one of the central heating part 10 and the peripheral heating parts 20.

Moisture sensors (not shown) to sense moisture or a liquid may be disposed at the positions where the central heating part 10 and the peripheral heating parts 20 are formed. Such a moisture sensor senses sweat of a sleeping person or urine of a child and applies a sensing signal corresponding to a sensing result to the control unit 50, thus warning a user whether or not moisture is sensed or operating the central heating part 10 and the peripheral heating parts 20 to dry moisture. For example, the control unit 50 receives sensing signals corresponding to the sensing results of the moisture sensors from the moisture sensors, and outputs a warning or controls the switching unit 40 to supply power to at least one of the central heating part 10 and the peripheral heating parts 20 for a designated time according to the received sensing signals.

In the automatic mattress heating apparatus 1 in accordance with the present invention, the central heating part 10 and the peripheral heating parts 20 of the heating element for beds preferably include one of a planar-type heating element, a mesh-type heating element and a strip-type heating element which will be described later, respectively, and the respective types thereof will be described in detail below.

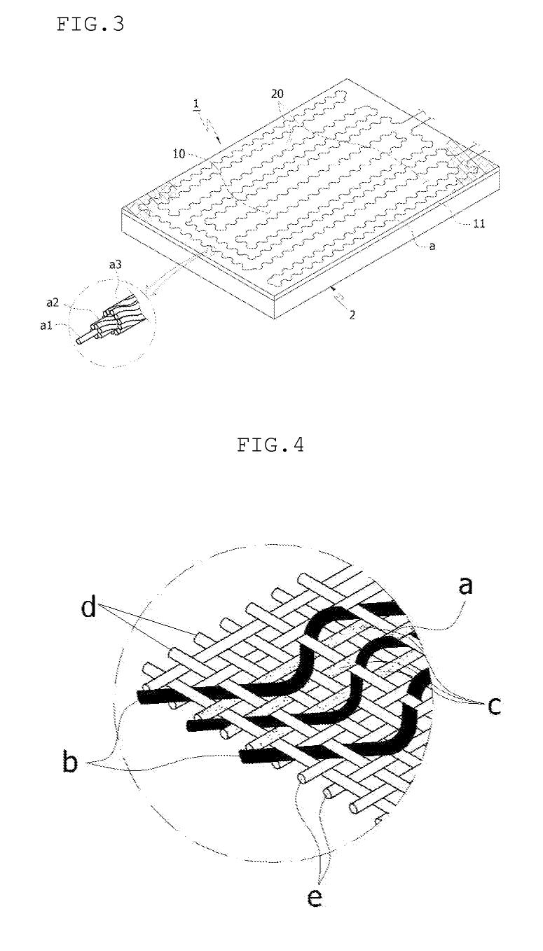

FIG. 3 is a view illustrating an automatic mattress heating apparatus in accordance with a first embodiment of the present invention.

With reference to FIG. 3, the automatic mattress heating apparatus in accordance with the first embodiment of the present invention includes a planar-type heating element 11 forming the central heating part 10 and the peripheral heating parts 20, and the planar-type heating element 11 is woven by preparing a planar fabric element knitted of fiber yarns supplied as wefts and warps, and then supplying heating lines a disposed in a wave form to at least one of the wefts and the warps.

Although the heating line a may be selected from among any kind of material which may be heated by power applied thereto, the heating line a in accordance with this embodiment includes a wire rod obtained by twisting conductive yarns and fabric yarns to have a fiber-like touch. For example, the heating line a, as shown in the enlarged portion of FIG. 3 includes a central yarn a1 disposed at the central area, a plurality of conductive yarns a2 coated with an insulating material and wound on the central yarn a1, and a plurality of outer fiber yarns a3 wound on the outer surfaces of the conductive yarns a, and the central yarn a1, the conductive yarns a2 and the outer fiber yarns a3 are formed in one bundle.

Here, the central yarn a1 is a high tension fiber yarn, such as an Aramide yarn or a Kevlar yarn, and thus although high tension is applied to the heating line a, the conductive yarns a2 wound on the central yarn a1 are stretched after the central yarn a1 is broken. Thereby, breakage of the conductive yarns a2 may be fundamentally prevented.

Further, although the conductive yarn a2 may be selected from among various materials and diameters which may transmit current, the conductive yarn a2 in accordance with this embodiment includes one selected from among metal yarns (normally, referred to as enamel wires) obtained by forming an insulating coating layer on a stainless wire, a titanium wire and a copper wire having a diameter of several tens of μm to several hundreds of μm. Here, although the number of strands of the conductive yarns a2 of the heating line a may be variously modified according to a desired heating capacity, 5 to 20 strands of the conductive yarns a2 in accordance with this embodiment are used as one bundle.

FIG. 4 is a view illustrating an automatic mattress heating apparatus in accordance with a first modification of the first embodiment of the present invention, i.e., an enlarged view of a portion of a planar-type heating element.

With reference to FIG. 4, the planar-type heating element 11 forming the central heating part 10 and the peripheral heating parts 20 includes protective yarns b to protect heating lines a from friction.

The protective yarns b are disposed adjacent to the heating lines a along the disposition path of the heating lines a, and include fabric yarns having a greater diameter than the diameter (denier) of the heating lines a.

Further, the heating element 11 in accordance with this embodiment includes heat transfer yarns c having excellent heat transfer characteristics to uniformly and rapidly transfer heat when the central heating part 10 and the peripheral heating parts 20 are heated. As the heat transfer yarns c, metal yarns or ceramic yarns having excellent thermal conductivity may be employed. The heat transfer yarns c are supplied as at least one of wefts d and warps e during a process of weaving the planar-type heating element forming the central heating part 10 and the peripheral heating parts 20, so as to be employed by the planar-type heating element.

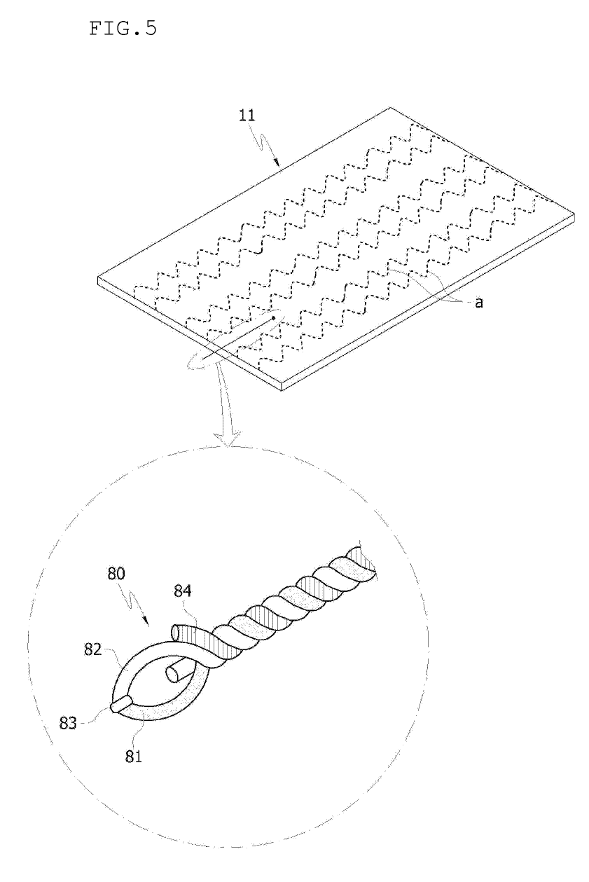

FIG. 5 is a view illustrating an automatic mattress heating apparatus in accordance with a second modification of the first embodiment of the present invention, i.e., an enlarged view of a portion of a planar-type heating element.

In the automatic mattress heating apparatus in accordance with the second modification, as shown in FIG. 5, a sensor device 80 functioning as the above-described temperature sensor or moisture sensor is easily disposed on the planar-type heating element. Here, the sensor device 80 is formed as a fiber yarn-type wire so as not to provide feeling of irritation to a sleeping person when the sleeping person lies thereon, and is supplied as wefts or warps during a process of weaving the planar-type heating element 11 or is sewn on the woven planar-type heating element 11.

Such a fiber yarn-type sensor device 80 is disposed adjacent to the central heating part 10 and the peripheral heating part 20. The sensor device 80 includes a first sensor line 81 provided with one end at which a connection terminal (not shown) is formed and the other end at which at least one electrode terminal (not shown) is formed, a second sensor line provided with one end at which a connection terminal (not shown) is formed and the other end at which at least one electrode terminal (not shown) is formed, and a detection element 83 connected to the electrode terminals of the first and second sensor lines 81 and 82. The first sensor line 81 is at least one strand formed by twisting a linear conductive member, and the second sensor line 82 is twisted with the first sensor line 81. Here, a fiber yarn 84 is twisted with the first sensor line 81 and the second sensor line 82, thereby producing a fiber-like soft touch.

If the sensor device 80 functions as a temperature sensor, the detection element 83 connected between the electrode terminals of the first and second sensor lines 81 and 82 includes a temperature detection element executing sensing of temperature. For example, the temperature detection element may be a negative temperature coefficient (NTC) thermistor element having negative temperature coefficient characteristics in which a resistance value decreases as temperature rises, or be a positive temperature coefficient (PTC) thermistor element having positive temperature coefficient characteristics in which a resistance value increases as temperature rises.

Further, if the sensor device 80 functions as a moisture sensor, the detection element 83 connected between the electrode terminals of the first and second sensor lines 81 and 82 includes a moisture detection element executing sensing of moisture. Although the moisture detection element employs a resistive moisture detection material, resistance of which is changed according to moisture, and a capacitive moisture detection material, capacitance of which is changed according to moisture, the moisture detection element may include various materials known as moisture sensing materials and composites thereof. For example, a material, resistance of which is changed according to moisture, such as ceramic or an inorganic material, is used as the resistive moisture detection material, and a moisture sensing polymer, such as polymethyl methacrylate (PMMA), is used as the capacitive moisture detection material.

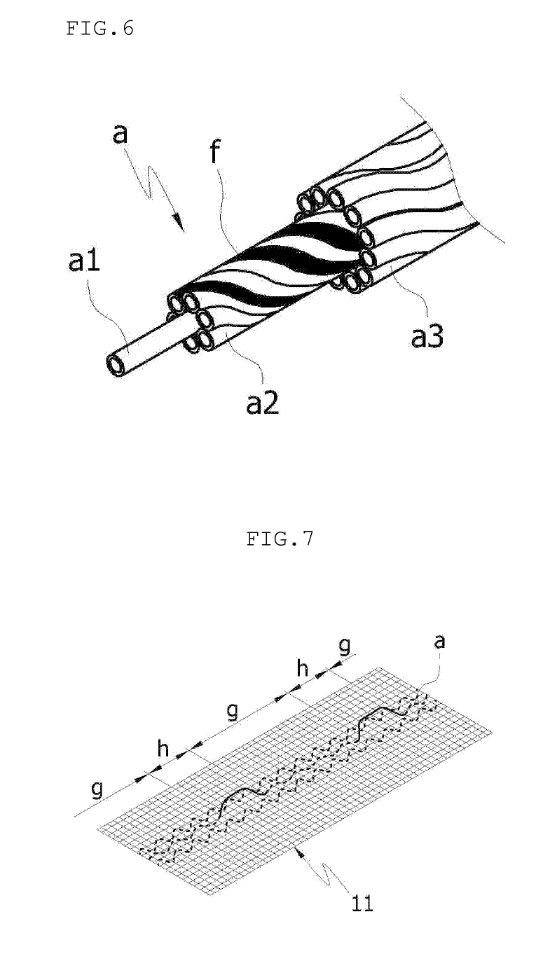

FIG. 6 is a view illustrating an automatic mattress heating apparatus in accordance with a third modification of the first embodiment of the present invention, i.e., an enlarged view of a heating line disposed in a planar-type heating element.

With reference to FIG. 6, the automatic mattress heating apparatus in accordance with this modification further includes temperature control lines f provided on the heating lines a at the central heating part 10 and the peripheral heating parts 20 to effectively control a heating temperature and to prevent a fire due to local overheating.

The temperature control line f serve to apply a resistance value changed according to temperature change, if the heating line a is heated above a predetermined temperature, to the control unit 50. The temperature control line f is a linear member disposed together with the heating line a and electrically connected to the control unit 50, and includes a conductive wire having resistance characteristics differing from the heating line a. The temperature control line f may be disposed together with the heating line a along the disposition path of the heating line a. The control unit 50 controls power applied to the heating line a according to the resistance value applied through the temperature control line f, thereby preventing the heating line a from being overheated.

Further, as shown in FIG. 6, the temperature control line f may be formed by winding a conductive yarn having a resistance value differing from the heating line a, i.e., a metal yarn, on the heating line a. If the temperature control line f is wound on the heating line a, as described above, when a specific portion of the heating line a is overheated, a resistance value is changed and the control unit 50 properly controls or interrupts power supply according to such a change of the resistance value, thereby preventing problems, such as abnormal overheating.

FIG. 7 is a view illustrating an automatic mattress heating apparatus in accordance with a fourth modification of the first embodiment of the present invention, i.e., a partial view illustrating a planar-type heating element.

With reference to FIG. 7, in the automatic mattress heating apparatus in accordance with the fourth modification, the planar-type heating element forming the central heating part 10 and the peripheral heating parts 20 includes heating line weaving sections g in which the heating lines a are woven integrally with a planar element, and heating line exposing sections h in which the heating lines a are not woven with the planar element and are exposed to the outside.

If the heating line exposing sections h are formed at a designated interval between the heating line weaving sections g in such a manner, the heating lines a are not woven with the planar element and are exposed to the outside in the heating line exposing sections h and thus the heating lines a are easily found. Accordingly, the exposed heating lines a may be electrically connected and a sensor may be conveniently connected to the exposed heating lines a.

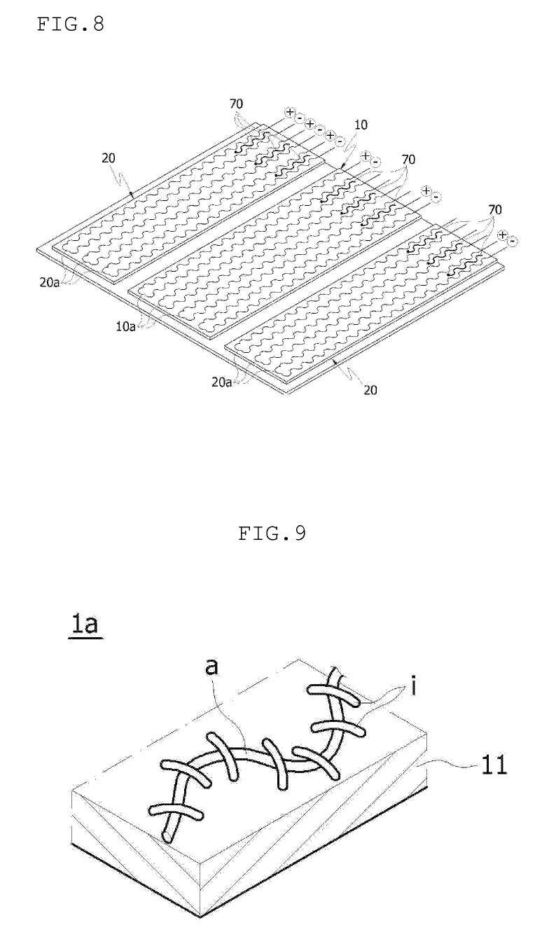

FIG. 8 is a view illustrating an automatic mattress heating apparatus in accordance with a fifth modification of the first embodiment of the present invention.

As shown in FIG. 8, the automatic mattress heating apparatus in accordance with the fifth modification includes a central heating part 10 and peripheral heating parts 20 in which a plurality of heating lines a is separated from each other by a designated interval, the central heating part 10 and the peripheral heating parts 20 respectively include a plurality of small heating circuits 10a and 20a including heating lines a disposed to independently receive power from a power supply unit 30, and sleeping person sensing units 70 are provided adjacent to the respective small heating circuits 10a and 20a.

Thereby, the position of a sleeping person sensed by the sleeping person sensing units 70 is applied to the control unit 50, and the control unit 50 drives the switching unit 40 to supply power to the heating lines a at a corresponding region, thereby enabling the automatic mattress heating apparatus to effectively execute heating according to the position and movement of the sleeping person.

That is, the central heating part 10 includes a plurality of small heating circuits 10a including the heating lines a disposed to receive power from the power supply unit 30, independently of the peripheral heating parts 20. Further, each of the peripheral heating units 20 includes a plurality of other small heating circuits 20a including the heating lines a disposed to receive power from the power supply unit 30, independently of the central heating part 10. The sleeping person sensing units 70 are respectively provided adjacent to the small heating circuits 10a of the central heating part 10 and the small heating circuits 20a of the peripheral heating parts 20.

FIG. 9 is a view illustrating an automatic mattress heating apparatus in accordance with a second embodiment of the present invention, i.e., a partial view of a planar-type heating element.

With reference to FIG. 9, an automatic mattress heating apparatus 1a in accordance with the second embodiment includes a planar-type heating element 11 forming a central heating part 10 and peripheral heating parts 20 and obtained by fixing heating lines a to a planar element formed of a material selected from among fabric, leather, non-woven fabric and foam, through embroidery.

The automatic mattress heating apparatus 1a in accordance with the second embodiment may be manufactured using an embroidery machine. That is, under the condition that the planar element (base fabric) formed of fabric, etc. is disposed on the embroidery machine, the heating lines a are supplied as embroidery yarns to form the central heating part 10 and the peripheral heating parts 20 and are fixed to the base fabric using an under thread i through embroidery.

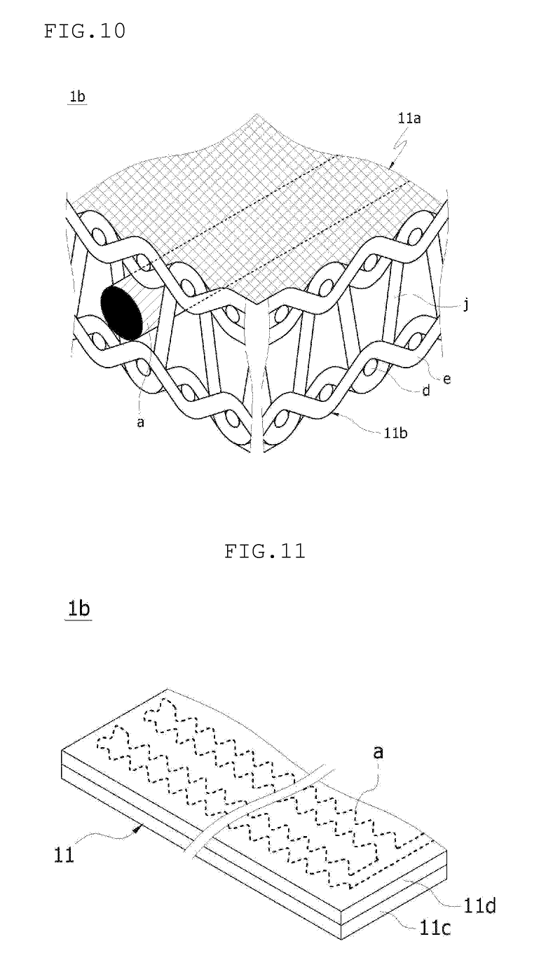

FIGS. 10 and 11 are views illustrating an automatic mattress heating apparatus in accordance with a third embodiment of the present invention, i.e., enlarged perspective views schematically illustrating an essential portion of the automatic mattress heating apparatus.

With reference to FIGS. 10 and 11, an automatic mattress heating apparatus 1b in accordance with the third embodiment includes a planar-type heating element 11 forming a central heating part 10 and peripheral heating parts 20 and obtained by disposing heating lines a within a planar element formed of a material selected from among fabric, leather, non-woven fabric and foam.

Since, in such an automatic mattress heating apparatus 1b in accordance with the third embodiment, the heating lines a are disposed within the planar-type heating element 11, even if external force (particularly, external force applied to a plane in the vertical direction) is applied, the heating lines a are not easily damaged.

If the planar-type heating element of the automatic mattress heating apparatus 1b in accordance with the third embodiment is formed of fabric, duplex fabric provided with a space formed therein may be used, as shown in FIG. 10. That is, the heating lines a may be disposed in a space formed between an upper fabric part 11a and a lower fabric part 11b of the duplex fabric woven by wefts d, warps e and connection yarns j during the weaving process of the duplex fabric, or may be inserted into the space after weaving of the duplex fabric.

Further, if the planar-type heating element of the automatic mattress heating apparatus 1b in accordance with the third embodiment is formed of foam, heating lines a forming a central heating part 10 and peripheral heating parts 20 are disposed on the upper surface of a lower foam planar element part 11c and then an upper foam planar element part 11d is attached thereto. If the heating lines a are disposed within the foam planar element in such a manner, a heating element executing buffering and cushioning functions due to foam may be implemented.

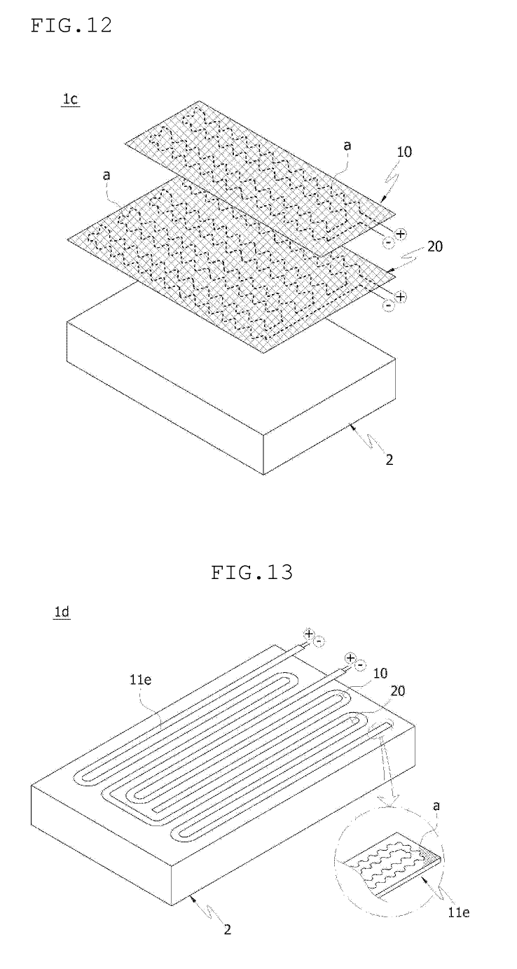

FIG. 12 is a view illustrating an automatic mattress heating apparatus in accordance with a fourth embodiment of the present invention in which a central heating part and a peripheral heating part are separated from each other.

With reference to FIG. 12, an automatic mattress heating apparatus 1c in accordance with the fourth embodiment includes a mesh-type heating element forming the central heating part 10 and the peripheral heating part 20 and woven by preparing a mesh-type planar element having a mesh net structure knitted of fiber yarns supplied as wefts and warps and then supplying heating lines a disposed in a wave form to at least one of the wefts and the warps.

The automatic mattress heating apparatus 1c in accordance with the fourth embodiment is formed of the mesh-type heating element, thus obtaining sufficient ventilation. Particularly, since the mesh-type heating element having a mesh net structure has a compact and simple configuration, the central heating part 10 and the peripheral heating part 20 are not integrated into one unit, and are individually provided, i.e., the peripheral heating part 20 having a size corresponding to the overall size of a bed throughout which the heating lines a are disposed is formed and the central heating part 10 is attached to the peripheral heating part 20, as shown in FIG. 12.

Accordingly, the automatic mattress heating apparatus 1c in accordance with the fourth embodiment may be used in a manner in which power is supplied to the peripheral heating part 20 when a heating function in regard to the entirety of the bed is desired to be executed, and power is supplied to the central heating part 10 when a heating function in regard to only the central portion of the bed is desired to be executed.

If the configuration of FIG. 12 is applied to the fundamental structure of the present invention, the heating element for beds is illustrated as including a first heating part corresponding to the peripheral heating part 20 and a second heating part corresponding to the central heating part 10, and the control unit 50 controls the switching unit 40 to supply power supplied from the power supply unit 30 to one of the first heating part and the second heating part of the heating element for beds. Further, the first heating part is disposed on the entire surface of the mattress 2 to heat the entirety of the heated area of the mattress 2 and the second heating part is disposed at the central portion of the mattress 2 to heat the central portion of the heated area of the mattress 2. Particularly, the second heating part may overlap the upper surface of the first heating part.

In the present invention, as described above, the central heating part 10 and the peripheral heating parts 20 may be integrated into one unit, or the central heating part 10 and the peripheral heating part 20 may be separately provided, as shown in FIG. 12.

FIG. 13 is a view illustrating an automatic mattress heating apparatus in accordance with a fifth embodiment of the present invention.

With reference to FIG. 13, an automatic mattress heating apparatus 1d in accordance with the fifth embodiment includes a strip-type heating element 11e forming a central heating part 10 and peripheral heating parts 20. Although the strip-type heating element 11e may be directly attached to a mattress 2, this embodiment exemplarily illustrates the strip-type heating element 11e as being sewn on a cover of the mattress 2 to form the central heating part 10 and the peripheral heating parts 20.

The strip-type heating element 11e is woven by preparing a strip-type planar element knitted of fiber yarns supplied as wefts and warps and then supplying heating lines a disposed in a wave form to at least one of the wefts and the warps, as shown in an enlarged portion of FIG. 13.

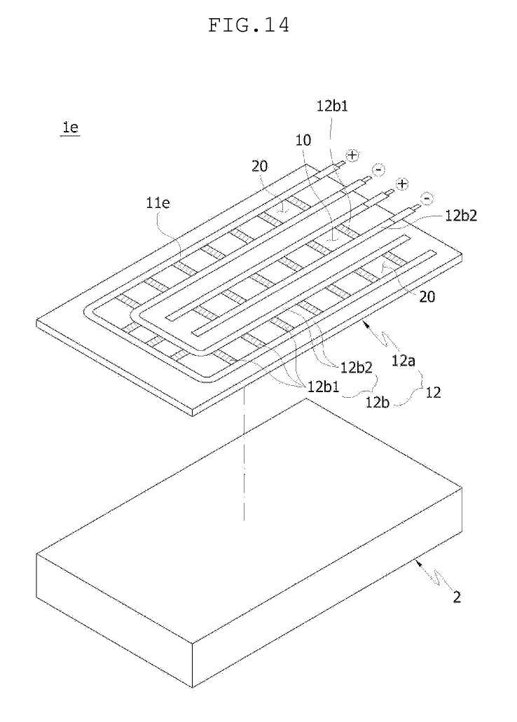

FIG. 14 is a view illustrating an automatic mattress heating apparatus in accordance with a sixth embodiment of the present invention.

With reference to FIG. 14, an automatic mattress heating apparatus 1e in accordance with the sixth embodiment includes a conductive polymer planar-type heating element 12 forming a heating circuit 12b (i.e., heating lines) using a conductive polymer on the surface of a planar element as a central heating part 10 and peripheral heating parts 20.

The conductive polymer planar-type heating element 12 in accordance with the sixth embodiment is provided by forming the heating circuit 12b satisfying desired circuit patterns of the central heating part 10 and the peripheral heating parts 20 on the surface of the planar element 12a formed of fabric using a conductive polymer obtained by mixing a polymer and a conductive material, such as carbon, metal nano-particles (nano-particles of a conductive metal, such as silver or copper), a metal oxide or metal oxide particles. Further, the heating circuit 12b includes heating circuit parts 12b1 executing a heating action, and power supply circuit parts 12b2 supplying power to the heating circuit parts 12b1. The heating circuit parts 12b1 executing the heating action are formed by applying a conductive polymer having a relatively large resistance value to the surface of the planar element 12a, and the power supply circuit parts 12b2 supplying power to the heating circuit parts 12b1 are formed by applying a conductive polymer having a relatively low resistance value and excellent conductivity, such as gold or silver, to the surface of the planar element 12a.

Further, the configurations described in the first and fifth modifications of the first embodiment of the present invention may be selectively applied to the above-described automatic mattress heating apparatuses in accordance with the second to sixth embodiments of the present invention.

### MODE FOR INVENTION

Although the above-described automatic mattress heating apparatuses in accordance with the preferred embodiments of the present invention have been exemplarily illustrated with reference to the accompanying drawings, it will be apparent to those skilled in the art that various modifications and variations can be made in the present invention without departing from the spirit or scope of the invention.

### INDUSTRIAL APPLICABILITY

The present invention provides an automatic mattress heating apparatus which actively heats a part or the entirety of a heated area of a mattress for beds according to the number of sleeping persons, the positions of the sleeping persons, or the movement of the sleeping persons to prevent waste of energy and is applied to a mattress for large beds for two or more persons.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. An automatic mattress heating apparatus comprising:
a power supply unit;
a heating element for beds including a central heating part and peripheral heating parts heated by power supplied from the power supply unit and executing a heating action;
a switching unit executing switching of the power supplied from the power supply unit to supply the power to at least one of the central heating part and the peripheral heating parts of the heating element for beds; and
a control unit to control switching of the power by the switching unit,
wherein the central heating part is disposed to heat a central portion of a heated area of a mattress, and the peripheral heating parts are disposed to heat remaining peripheral portions of the heated area of the mattress except for the central portion.

2. The automatic mattress heating apparatus according to claim 1, wherein:
the central heating part is disposed in the lengthwise direction from the central portion of the upper region of the mattress to the central portion of the lower region of the mattress; and
the peripheral heating parts are disposed adjacent to both sides of the central heating part.

3. The automatic mattress heating apparatus according to claim 1, further comprising a sleeping person sensing unit provided at at least one of a position where the central heating part is disposed and positions where the peripheral heating parts are disposed so as to sense the sleeping position of a sleeping person.

4. The automatic mattress heating apparatus according to claim 3, wherein the sleeping person sensing unit includes load sensors to respectively sense load applied to the central portion at which the central heating part is disposed and loads applied to the peripheral portions at which the peripheral heating parts are disposed.

5. The automatic mattress heating apparatus according to claim 3, wherein the control unit receives a sensing signal corresponding to a sensing result of the sleeping person sensing unit from the sleeping person sensing unit, and controls the switching unit to supply the power to at least one of the central heating part and the peripheral heating parts at which the sleeping person is located according to the received sensing signal.

6. The automatic mattress heating apparatus according to claim 3, wherein:
the central heating part includes a plurality of small heating circuits including heating lines disposed to receive power from the power supply unit, independently of the peripheral heating parts;
the peripheral heating units include a plurality of other small heating circuits including heating lines disposed to receive power from the power supply unit, independently of the central heating part; and
the sleeping person sensing unit is provided adjacent to the small heating circuits of the central heating part and the small heating circuits of the peripheral heating parts.

7. The automatic mattress heating apparatus according to claim 1, wherein:
the central heating part and the peripheral heating parts of the heating element for beds respectively include one of a planar-type heating element, a mesh-type heating element and a strip-type heating element;
the planar-type heating element is formed in one of a first shape woven by disposing heating lines in a wave form to supply power to the central heating part and the peripheral heating parts on a planar fabric element knitted of fiber yarns supplied as wefts and warps, a second shape obtained by fixing heating lines supplied as embroidery yarns to a planar element formed of a material selected from among fabric, leather, non-woven fabric and foam, using an under thread through embroidery, a third shape obtained by disposing heating lines within a planar element formed of a material selected from among fabric, leather, non-woven fabric and foam, and a fourth shape obtained by disposing heating lines on the surface of a planar element using a conductive polymer;
the mesh-type heating element is formed in a fifth shape woven by disposing heating lines in a wave form to supply power to the central heating part and the peripheral heating parts on a mesh-type planar element having a mesh net structure knitted of fiber yarns supplied as wefts and warps; and
the strip-type heating element is formed in a sixth shape woven by disposing heating lines in a wave form to supply power to the central heating part and the peripheral heating parts on a strip-type planar element knitted of fiber yarns supplied as wefts and warps.

8. The automatic mattress heating apparatus according to claim 7, wherein each of the heating lines includes a central yarn disposed at the central area, a plurality of conductive yarns coated with an insulating material and wound on the central yarn, and a plurality of outer fiber yarns wound on the outer surfaces of the plurality of conductive yarns, the central yarn, the plurality of conductive yarns and the plurality of outer fiber yarns being formed in one bundle.

9. The automatic mattress heating apparatus according to claim 7, further comprising protective yarns having a greater diameter than the diameter of the heating lines and disposed adjacent to the heating lines along the disposition path of the heating lines to protect the heating lines from friction.

10. The automatic mattress heating apparatus according to claim 7, further comprising temperature control lines having resistance characteristics differing from the heating lines and disposed together with the heating lines along the disposition path of the heating lines to apply a resistance value changed, when the heating lines are heated above a predetermined temperature, to the control unit.

11. The automatic mattress heating apparatus according to claim 10, wherein the control unit controls power applied to the heating lines according to the resistance value applied through the temperature control line to prevent the heating lines from being overheated.

12. The automatic mattress heating apparatus according to claim 7, further comprising heat transfer yarns having excellent heat transfer characteristics to uniformly and rapidly transfer heat when the central heating part and the peripheral heating parts are heated.

13. The automatic mattress heating apparatus according to claim 7, wherein the heating element formed in each shape at the central heating part and the peripheral heating parts is divided into heating line weaving sections in which the heating lines are woven integrally with the planar element, and heating line exposing sections in which the heating lines are not woven with the planar element and are exposed to the outside.

14. The automatic mattress heating apparatus according to claim 1, wherein the central heating part and the peripheral heating parts are integrated into one unit, or the central heating part and the peripheral heating parts are separately provided.

15. The automatic mattress heating apparatus according to claim 1, further comprising sensor units disposed adjacent to the central heating unit and the peripheral heating units, wherein:
each of the sensor units includes at least one first sensor line formed of a conductive linear member and provided with a connection terminal formed at one end thereof and at least one connection terminal formed at the other end thereof, a second sensor line formed of another conductive linear member and provided with a connection terminal formed at one end thereof and at least one connection terminal formed at the other end thereof, and a detection element connected to the electrode terminals of the first and second sensor lines; and
the first sensor line is formed by twisting the conductive linear member, and the second sensor line is twisted with the first sensor line.

16. The automatic mattress heating apparatus according to claim 15, wherein the detection element includes at least one of a temperature detection element and a moisture detection element.

17. The automatic mattress heating apparatus according to claim 1, further comprising a moisture sensor at at least one of the position of the central heating part and the positions of the peripheral heating parts.

18. The automatic mattress heating apparatus according to claim 17, wherein the control unit receives a sensing signal corresponding to a sensing result of the moisture sensor from the moisture sensor, and outputs a warning or controls the switching unit to supply power to at least one of the central heating part and the peripheral heating parts for a designated time according to the received sensing signal.

19. The automatic mattress heating apparatus according to claim 1, wherein the power supply unit includes a central heating part power supply unit to supply first power corresponding to a power consumption rate of the central heating part and a peripheral heating part power supply unit to supply second power corresponding to power consumption rates of the peripheral heating parts, and a supply capacity of the first power supplied to the central heating part and a supply capacity of the second power supplied to the peripheral heating parts are different.

20. An automatic mattress heating apparatus comprising:
a power supply unit;
a heating element for beds including a first heating part and a second heating part heated by power supplied from the power supply unit and executing a heating action;
a switching unit executing switching of the power supplied from the power supply unit to supply the power to one of the first heating part and the second heating part of the heating element for beds; and
a control unit to control switching of the power by the switching unit,
wherein the first heating part is disposed on the entire surface of a mattress to heat the entirety of a heated area of a mattress, and the second heating part overlaps the upper surface of the first heating part at the central portion of the mattress to heat the central portion of the heated area of the mattress.
